(19) United States
(12) Patent Application Publication
(10) Pub. No.: US 2009/0013269 A1
(43) Pub. Date: Jan. 8, 2009

(54) MULTIPLE LAYER TITLE BAR DISPLAY

(75) Inventor: Vikram Khandpur, Kirkland, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/773,758

(22) Filed: Jul. 5, 2007

(51) Int. Cl. G06F 3/048

(52) U.S. Cl. 715/764

(57) ABSTRACT

A title bar can be displayed through use of different layers. A default layer displays information of general importance to a user. A non-default layer can be presented to a user based on specific circumstances. The non-default layer is presented according to defined criteria. The default layer can be re-displayed to the user after completion of the criteria associated with the non-default layer.

### TECHNICAL FIELD

The subject specification relates generally to electronic device display and in particular to presenting title bars in a layered configuration.

### BACKGROUND

In recent decades, personal electronic devices have become important in society. The impact of personal electronic devices transcends many disciplines ranging from business transactions (e.g., transfer of commodities from a personal digital assistant) to interpersonal communications (e.g., cellular telephone call between two individuals.) As importance of these devices grows, technology that develops around them also grows. Technological developments also transcend many disciplines, including both hardware and software innovations.

One area of large growth in recent years relates to miniaturization of personal electronic devices. Miniaturization of devices allows more capabilities to be contained in a single unit. However, different capabilities are performed through a relatively small screen. Screen real estate has become more important since a greater number of functions are taking place on one device in conjunction with smaller screen size. There is a limited amount of physical space on a screen that can be utilized to display information.

An electronic device can use a title bar to convey information. A title bar provides information to a user that is of general importance. For example, a title bar displays time and data information, signal strength, battery life, etc. Different information displayed within a title bar commonly appears in the same location. For example, a far right side of a title bar can display time and date information when a user turns an electronic device to an ‘on’ state.

### SUMMARY

The following presents a simplified summary of the specification in order to provide a basic understanding of some aspects of the specification. This summary is not an extensive overview of the specification. It is intended to neither identify key or critical elements of the specification nor delineate the scope of the specification. Its sole purpose is to present some concepts of the specification in a simplified form as a prelude to the more detailed description that is presented later.

Conventional display configurations have a partitioned title bar that displays different icons based on an occurrence related to an electronic device (e.g., an incoming call to a cellular telephone.) There can be numerous problems associated with a conventional configuration. In one example, there can be a greater amount of data that should be displayed then room available on a partitioned title bar and a user does not appreciate essential information (e.g., there are five pieces of highly important details, but there are four title bar sections to display details.) In another example, information is presented in a manner that makes appreciation of information difficult (e.g., icons are made small and difficult to view, information overflows the title bar and obstructs information in other locations, the user have to physically scroll through the title bar, etc.)

The subject specification discloses information that relates to the utilization of layers in presenting a title bar. When a pre-determined event occurs (e.g., incoming phone call, a time for an appointment is reached, etc.), an event-specific title bar is selected for temporary display over a default title bar. This allows for relevant information to be presented at appropriate times as well as for a user to have an adequate ability to appreciate information. Title bars are provided with different priorities, and based on different conditions (e.g., importance of information, importance of the source of the information, action an electronic device currently engages, etc.) a different title bar is disclosed.

For example, a default title bar for a cellular telephone can contain time/date information, battery life, and signal strength. The default title bar is displayed at a lowest priority and other title bars can be presented in its place. An incoming call can be received by the cellular telephone. An incoming call title bar is presented over the default title bar disclosing information relevant to the incoming call (e.g., urgency, telephone number, etc.) After a set expiration of at least one condition (e.g., after five seconds), there is removal of the incoming call title bar and the default title bar is presented to the top.

The following description and the annexed drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates an example title bar selection system in accordance with an aspect with an aspect of the subject specification.

FIG. 2 illustrates an example control component in accordance with an aspect of the subject specification.

FIG. 3 illustrates an example operating of a selection component for selection of a title bar in accordance with an aspect of the subject specification.

FIG. 4 illustrates an example transmission component in accordance with an aspect of the subject specification.

FIG. 5 illustrates an example title bar selection system with a creation component in accordance with an aspect of the subject specification.

FIG. 6 illustrates an example title bar selection system with an advertisement component in accordance with an aspect of the subject specification.

FIG. 7 illustrates an example title bar selection system with a modification component in accordance with an aspect of the subject specification.

FIG. 8 illustrates an example title bar selection system with an interaction component in accordance with an aspect of the subject specification.

FIG. 9a illustrates an example screen with a default title bar in accordance with an aspect of the subject specification.

FIG. 9b illustrates an example screen with a non-default title bar in accordance with an aspect of the subject specification.

FIG. 10 illustrates an example methodology for following criteria concerning received information in accordance with an aspect of the subject specification.

FIG. 11 illustrates an example methodology for selection of a title bar in accordance with an aspect of the subject specification.

FIG. 12 illustrates an example of a schematic block diagram of a computing environment in accordance with the subject specification.

FIG. 13 illustrates an example of a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. As another example, an interface can include I/O components as well as associated processor, application, and/or API components.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

For purposes of simplicity of explanation, methodologies that can be implemented in accordance with the disclosed subject matter were shown and described as a series of blocks. However, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed throughout this specification are capable of being stored on an article of manufacture to facilitate transporting and transferring such methodologies to computers. The term article of manufacture, as used, is intended to encompass a computer program accessible from any computer-readable device, carrier, or media.

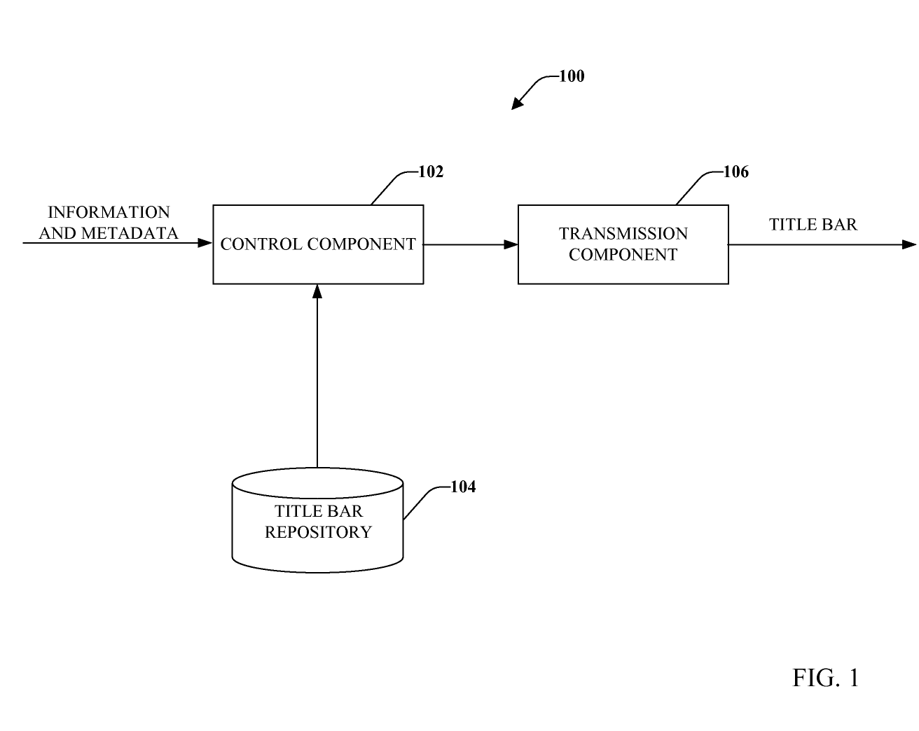

FIG. 1 discloses an example multi-layer title bar system 100. A title bar is a portion of a display of an electronic device that is not used for generally used for primary manipulation. Title bars can be at an edge of the display, including a top of the display, a bottom of the display, or a side of the display. The system 100 can be implemented on an electronic device, such as a cellular telephone, personal digital assistant, portable media player, etc. Information can enter the electronic device with metadata (e.g., source information, information type, file size, etc.); however, metadata does not need to be present. Examples of information are word processing files, telephone calls, electronic mail (e-mail) messages, and the like. Common metadata is support information that relates to information. For example, an incoming e-mail message can have metadata such as a file size, the presence of an attachment and the attachment file size, identity of a sender, a device name that sent the message, etc. Information can include both an incoming service as well as an internal application.

A control component 102 can perform analysis upon received information and metadata. Information can arise from inside the electronic device (e.g., a stored appointment) or from outside the electronic device (e.g., a text message.) Based on the analysis, a title bar is selected that can represent appropriate characteristics of the information and metadata. Various title bars can be stored in a title bar repository 104. The repository 104 can hold a plurality of different title bars that can be presented to a user.

The control component 102 extracts an appropriate title bar from the title bar repository 104 and transfers the title bar to the transmission component 106. The transmission component 106 can present the title bar to the user. This can be done through a number of different embodiments. According to one embodiment, the transmission component 106 incorporates a display that discloses the title bar to a user. However, the transmission component 106 can transfer the title bar to another unit capable of displaying the title bar.

The control component 102 can be in continuous communication with the transmission component 106. For example, a selected title bar can have a pre-set limit to display for five seconds. The control component 102 can signal to the transmission component 106 the amount of time a transferred title bar should display as well as other relevant information (e.g., the brightness of the title bar.) According to another embodiment, the control component 102 sends periodic signals to the transmission component 104 concerning what should be displayed to the user.

Furthermore, the control component 102 can supply a default title bar to the transmission component 106. The control component 102 can obtain the default title bar from the title bar repository 104 or hold the default title bar in internal storage. Different title bars that are to be displayed are transferred to the transmission component 106 depending on the appropriate title bar at a given time.

According to one embodiment, the transmission component 106 holds a default title bar that is presented to a user. The transmission component 106 presents the default title bar unless an override title bar is transferred from the control component 102. When the override title bar is transferred, the transmission component 106 displays the override title bar in accordance with instructions from the control component 102 (e.g., how long to display a title bar.) Once instructions have been met and the override title bar is no longer to be presented, the transmission component 106 resumes display of the default title bar. Various title bars can be appreciated as different layers. At different times, different layers are presented to a user based on a priority system (e.g., z-priority.) Therefore, the system 100 can display a different layer to a user at a different time.

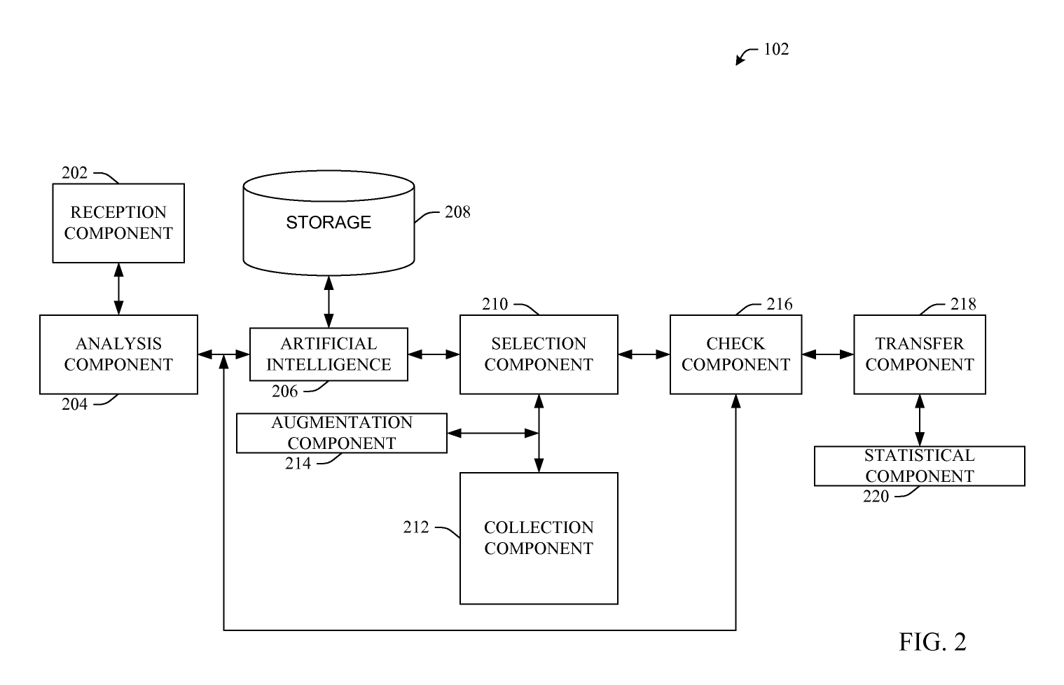

FIG. 2 discloses an example control component 102 of FIG. 1. A reception component 202 obtains information and metadata. For example, the control component 102 can be a personal digital assistant that receives a text message. The reception component 102 receives the text message as well as various metadata associated with the text message. In this example, metadata can include the Internet Protocol address of the device that sent the text message, the memory space size of the text message, the time the text message was sent, etc.

An analysis component 204 examines received information, metadata, or both. Examination can include performance of a number of different actions. For example, the analysis component 204 can ascertain the content of the information. In another example, the analysis component 204 can determine file size of information. Furthermore, the analysis component 204 can merely identify presence of metadata.

Artificial intelligence 206 can make various inferences and/or determinations that relate to the information and/or metadata. Artificial intelligence 206 makes at least one inference or at least one determination or both that concerns election of a non-default title bar. For example, a text message can be received from a cellular telephone owned by a person named ‘Joe Smith.’ An inference can be made that the text message is from ‘Joe Smith.’ However, another person using the cellular phone could have send the message, so artificial intelligence 206 makes an inference that it is likely ‘Joe Smith’ sent the text message.

The artificial intelligence 206 can construct models concerning operating of control component 102. For example, previous messages from the cellular telephone have been from ‘Joe Smith.’ Therefore, a model can be constructed that messages from the cellular telephone are commonly from ‘Joe Smith.’ The artificial intelligence 206 can learn from previous interactions and hold information in a storage component 208.

Artificial intelligence 206 can employ one of numerous methodologies for learning from data and then drawing inferences and/or making determinations through models relating to information and/or metadata so constructed (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein.

Methods also include methods for the capture of logical relationships such as theorem provers or more heuristic rule-based expert systems. Inferences derived from such learned or manually constructed models can be employed in optimization techniques, such as linear and non-linear programming, that seek to maximize some objective function. Examples of operation of artificial intelligence 206 can include determining a source of information, making an inference as to context of the information, etc.

In addition, there can be instances where incoming information does not merit a different title bar. For example, an electronic mail (e-mail) message can enter the control component 102. However, a user of an electronic device 102 can be composing an important message that is to be sent out as quickly as possible. A title bar change can be distracting to the user and this can be detrimental on a user goal of quickly sending the message. Therefore, the artificial intelligence 206 can make a determination that there should be no title bar change due to the importance of the message. According to one embodiment, the artificial intelligence 206 delays a title bar change. As a continuation of the previous example, a title bar change can take place after composition and sending of an important message.

A selection component 210 elects a non-default title bar for presentment over a default title bar of a device based on an occurrence of an inbound service or metadata associated with the inbound service or execution of an internal application or a combination thereof. An inbound service is external information entering a device with the selection component 210. Examples of an inbound service include a cellular telephone call, an e-mail message, etc. An internal application is information from within the device (e.g., a notice that battery level is low.) For example, storage 208 can hold an appointment for a user. Five minutes before the appointment, the selection component 210 can elect an appropriate title bar.

Typically, a visual display presents a default title bar that discloses general information (e.g., time, date, battery life, etc.) However, there can be instances where a different title bar is more beneficial. When a different title bar is more beneficial, the selection component 210 elects the non-default title bar to display. The selection component 210 can utilize internal logic in election of a non-default title bar.

According to one embodiment, the selection component 210 makes an election based on similar non-default title bars. For example, there can be an incoming cellular telephone call. Two similar non-default title bars that relate to cellular telephone calls are held in the title bar repository 104 of FIG. 1; one non-default title bar is blue and another non-default title bar is pink. A user of a device that includes the selection component 210 can be a male, therefore, a blue non-default title bar can be appropriate (e.g., from a determination can be made from a user profile held in storage 208.) and the selection component 210 can make the appropriate election.

The selection component 210 can utilize a collection component 212 for obtaining a non-default tile bar layer. The collection component 212 can have the ability to process contents of the title bar repository 104 of FIG. 1 (e.g., a location that holds title bars.) For example, the title bar repository 104 of FIG. 1 can hold about ten different title bars. The selection component 210 can determine a title bar that relates to an incoming cellular telephone call should be used. The collection component 212 locates a relevant title bar and transfers the relevant title bar to the selection component 210.

An augmentation component 214 can integrate an elected non-default title bar with data that concerns the inbound service or metadata associated with the inbound service or execution of the internal application or a combination thereof. For example, if the relevant title bar includes a portion for a source of information, then the augmentation component 214 places source metadata into the relevant title bar. The augmentation component 214 can operate by finding an area of a non-default title bar that can receive data, determine appropriate data, and add the data to the non-default title bar

A check component 216 verifies applicability of the non-default title bar. Different errors can occur in operation of the control component 102 and the check component 216 can function to lower errors. For example, a non-default title bar can have an area for source metadata. However, the source metadata was not correctly entered by the augmentation component 214 (e.g., destination data was accidentally entered.) The check component 216 can identify this error and send a request to the augmentation component 214 to correct the error.

In another example, the selection component 210 elects an inappropriate non-default title bar. In this example, there can be an incoming telephone call. However, the selection component 210 accidentally elects a non-default title bar that is for an e-mail message. The check component 216 can identify the error, send a message to the selection component 210 to make a correction, and disregard the originally elected title bar. In another example, the artificial intelligence 206 makes a mistake concerning an inference. The check component 216 can send a message to the artificial intelligence 206 that concerns the mistake as well as a suggestion as to a possible resolution.

A transfer component 218 conveys the non-default title bar to an auxiliary location (e.g., the transmission component 106 of FIG. 1, a display component, etc.) The transfer component 218 can apply a non-default title bar over a default layer title bar; thus, the auxiliary location is a display. However, the transfer component 218 can send the non-default title bar to another component for further actions. For example, the transmission component 106 of FIG. 1 can perform actions of presenting the non-default title bar to a user.

A statistical component 220 can gather data that relates to the non-default title bar. Various data types can be beneficial for other components and the statistical component 220 can provide the data to component of the system 100 of FIG. 1. For example, the statistical component 220 can determine that the artificial intelligence 206 is making incorrect inferences (e.g., an incoming call has a voice of a female, but a named identifier is a male name.) The statistical component 220 transfers data to the artificial intelligence 206 and the artificial intelligence 206 can modify operation (e.g., no longer use a name associated with a telephone number.)

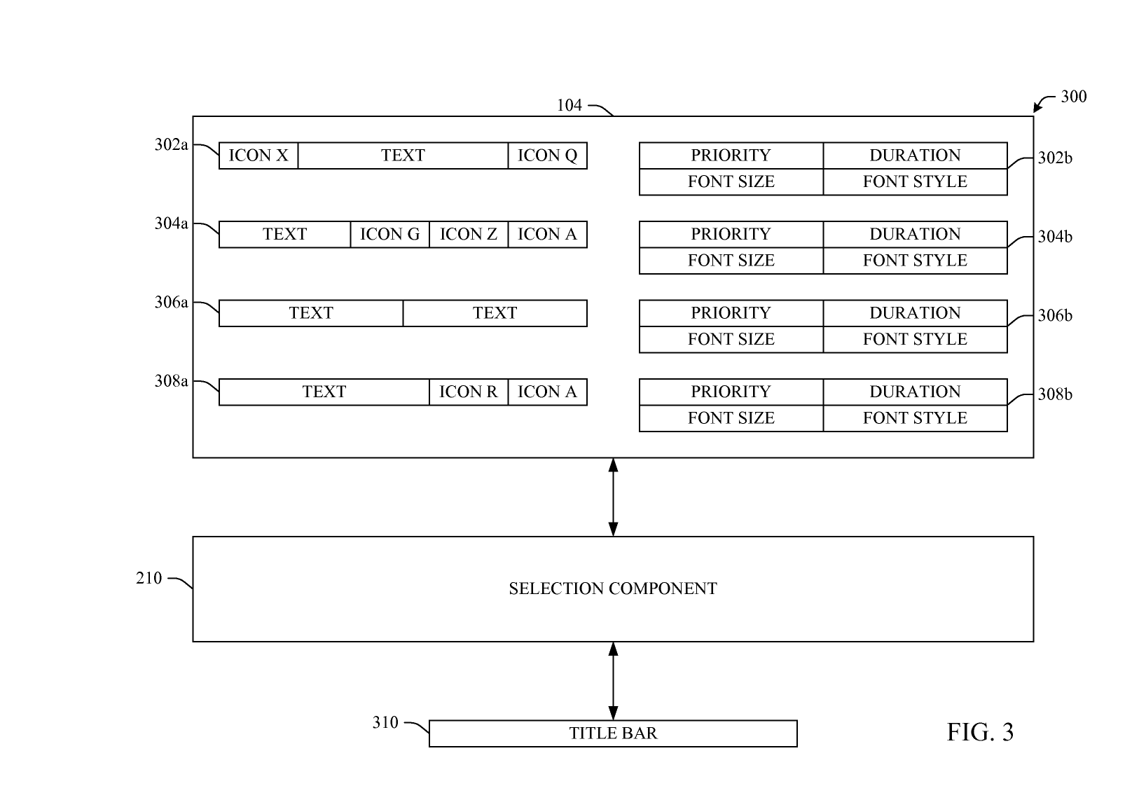

FIG. 3 discloses an example configuration 300 of operation of the selection component 210. A title bar repository 104 can hold at least about two title bars 302. In FIG. 3, four title bars 302a, 304a, 306a, and 308a are disclosed. Title bar 302a can represent a received message. For example, icon X can be of a mailbox, text can provide a number of a cellular telephone that sent the message, and icon Q can indicate if a sender of the received message is on a stored contact list (e.g., saved in storage 208 of FIG. 2.) A title bar portion can be dynamic and the selection component 210 can choose what to fill in portions (e.g., a symbol showing a message is from a contact) or leave a portion blank.

Title bar 304a can represent an appointment that initiates from an internal application. The title bar 304a can include text as to the time of the appointment. Furthermore, icon G can represent an appointment type (e.g., professional, personal, etc.), icon Z can represent importance of the appointment, and icon A can represent battery life. Title bars 302a-308a can have motion characteristics. For example, text can scroll and/or icons can flash.

Title bar 306a can represent an incoming telephone call. One text portion can disclose caller identification information while another text portion can disclose urgency of the incoming phone call. Title bar 308a can function as a default title bar and thus title bars 302a-306a can be non-default title bars. Text of 308a can display a company that makes an electronic device operating the configuration 300. Icon R can disclose a time while icon A can disclose battery life. Thus, title bars can share information, such as title bar 304a and title bar 308a share a display for battery life.

The title bars 302a-308a can associate with criteria 302b, 304b, 306b, and 308b. Example criteria can be priority (e.g., a ranking used to determine what title bar is displayed), duration (e.g., amount of time a title bar is displayed), font size (e.g., 6 point, 8 point, etc.), and font style (e.g., italics, bold, etc.) However, other criteria can associate with a title bar; for example font type (e.g., Times New Roman, Wingding, etc.) and/or minimum pixels used.

The selection component 210 elects an appropriate title bar 310. For example, if there is no reason for a non-default title bar to display, then the selection component 210 will not function and title bar 308a displays. The selection component 210 can employ zero-order priority that elects a title bar based on title bar priority criteria.

For example, title bar 304a can posses a priority of about one and duration of about 5 seconds while title bar 306a can posses a priority of about two and duration of about 3 seconds. An appointment can arise at a specific time, so the selection component 210 elects title bar 304a. About one second after title bar 304a is displayed there is an incoming call. Since title bar 306a has a lower priority then title bar 304a, title bar 306a is not displayed over title bar 304a. Furthermore, since title bar 306a duration does not last longer then the duration of title bar 304a (e.g., duration of title bar 306a is three seconds while duration remaining of title bar 304a is four seconds), title bar 306a is not displayed.

The selection component 210 can configure to delay a lower priority title bar. Using the previous example, once title bar 304a is finished being displayed (e.g., duration ends), title bar 306a is displayed in accordance with criteria 306b. Once there is completion of display of non-default title bars, the default title bar 308a is displayed.

The following is example computer code that can allow a user to select a default title bar (e.g., provided by an electronic device manufacturer.):

UserselectableList =
{
(VM icon, VM subject, VM priority); // (DEFAULT)
(New SMS icon, New SMS sender, SMS priority);
(New Email icon, New Email SUB, Email priority)
}

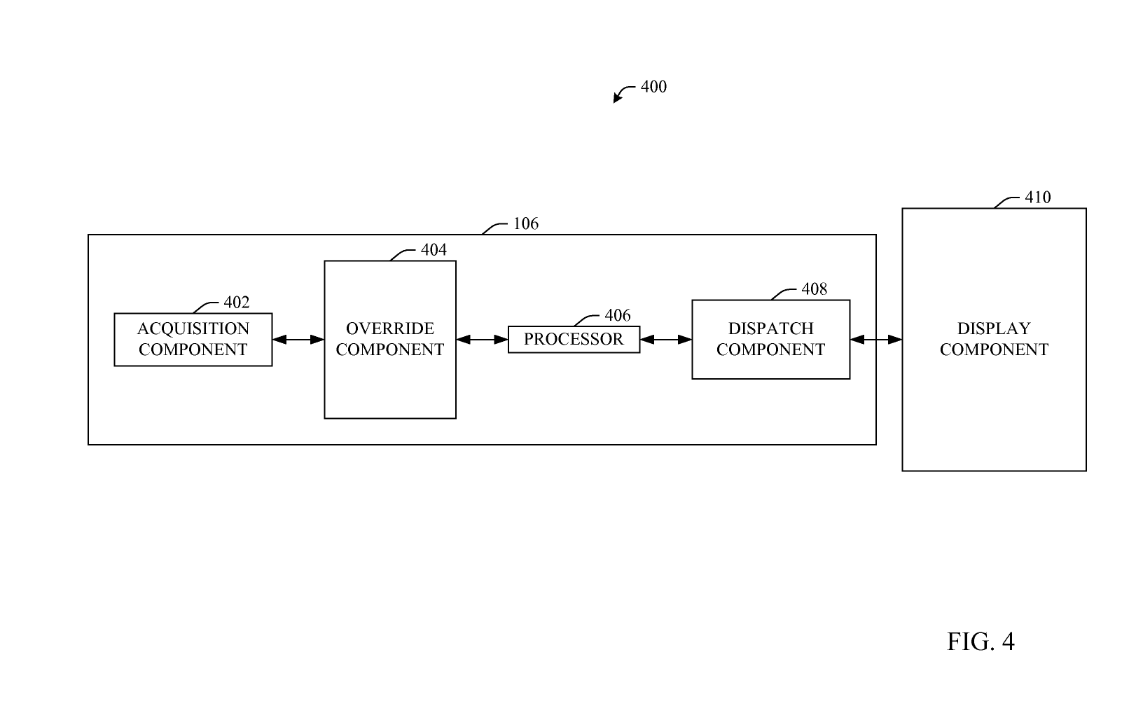

FIG. 4 discloses an example system 400 with a transmission component 106 and a display component 410. The transmission component 106 can include an acquisition component 402. The acquisition component 402 obtains a non-default title bar from a control component 102 of FIG. 1. The acquisition component 402 can also function to identify data that relates to the non-default title bar. For example, an electronic device running the system 400 can contain multiple control components and the acquisition component 402 can determine which control component transferred the non-default title bar.

An override component 404 can place the non-default title bar over the default title bar. The override component 404 can contain internal logic concerning placement of the non-default title bar. For example, the override component 404 can include the capability of identifying placement of a default title bar and place the non-default title bar directly over the default title bar. Placement of one title bar over another title bar can take place in a physical capacity, in a logical capacity, etc.

A processor 406 operates to coordinate various operations concerning the transmission component 106. For example, the processor 406 can present a default title bar when at an ‘on’ state. In operation of the transmission component 106, the default title bar can be presented and the override component 402 places the non-default title bar over the default title bar.

Furthermore, the processor 406 can regulate presentment of the non-default title bar in accordance with criteria of a non-default title bar. For example, the non-default title bar can have criteria relating to display for about five seconds. The processor 406 can include timing logic that determines when about five seconds are complete. When about five seconds are complete, the processor 406 can send a signal to the override component 404 that non-default title bar should be removed from atop the default title bar.

A dispatch component 408 transfers at least one title bar to a display component 410. This can include both the default title bar and the non-default title bar. The display component 410 can integrate into an electronic device running the transmission component 106 or it can be an independent unit. According to one embodiment, the display component 410 is a liquid-crystal screen capable of presenting images.

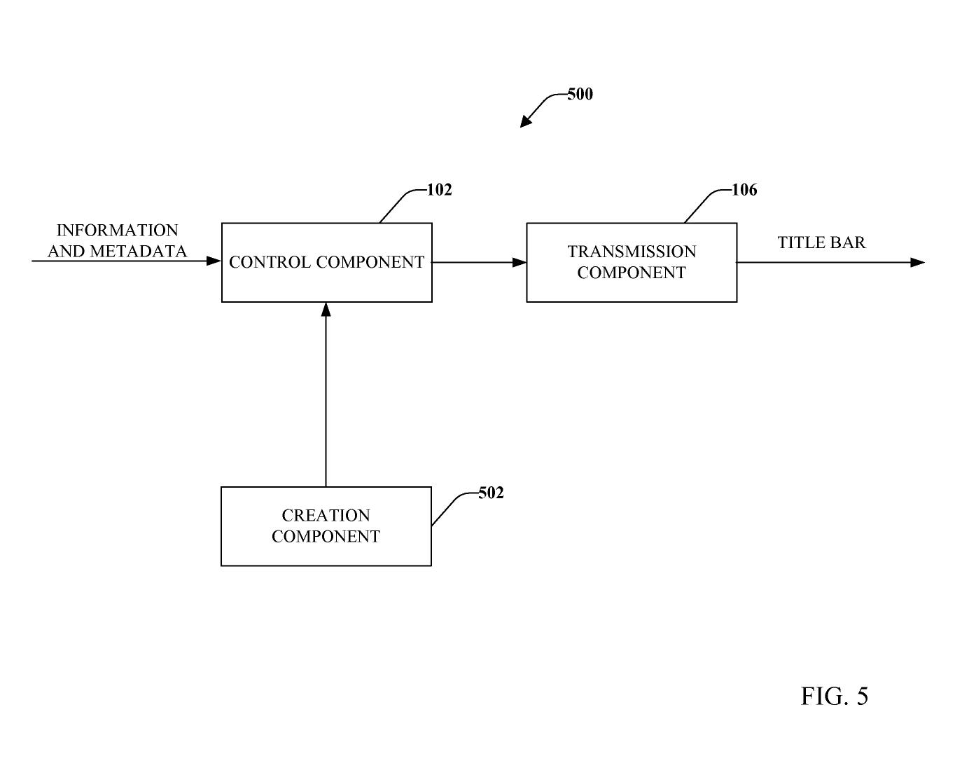

FIG. 5 discloses an example title bar display system 500 with a creation component 502. Information and metadata enter a control component 102. The information and metadata can come from an external location (e.g., inbound service) or an internal location (e.g., internal application.) The control component 102 can transfer a non-default title bar to a transmission component 106 that can engage a display component for presentment of the non-default title bar. There can be instances when a user of a device operating the system 500 desires to produce a new non-default title bar. A creation component 502 facilitates construction of a title bar that can be elected by the selection component. This includes both a default title bar and a non-default title bar since properties of title bars can change based on a priority scheme (e.g., a non-default title bar can change to a default title bar based on modification of priority.) The creation component 502 can utilize the display component 410 of FIG. 4 to allow a user to construct a title bar (e.g., through utilization of a graphical user interface.) A custom-built title bar can be saved in various locations, including the storage 208 of FIG. 2, the title bar repository 104 of FIG. 1, etc.

A manufactured device that operates the system 500 can have an expected use. For example, the manufactured device can be a portable electronic gaming system that plays games of company A. However, the manufactured device can be modified after entering a commerce stream thus that is can also play games of company B. When new games from company B become available, a user can desire to have a notice. The user can construct a custom title bar that discloses information relevant to a new game. Construction can include not only physical creation of a title bar (e.g., where icons are placed), but also criteria associated with the title bar (e.g., a priority level associated with a new title bar.)

According to one embodiment, the creation component 502 includes a correction component. A correction component adjusts priority concerning a newly created non-default title bar. For example, a user can create a new non-default title bar and request that it have a priority level of two (e.g., a third highest priority level after zero and one.) The correction component of the creation component 502 can adjust other title bars in accordance with the new non-default title bar (e.g., move a former third highest priority level title bar to fourth priority level, etc.)

However, there can be a configuration where a user is presented with a tool (e.g., wizard) that assists to user in creation of the non-default title bar. The tool can provide systematic instructions that a user can follow in creation of a non-default title bar. The tool can vary in complexity and different tools can be provided depending on the technical knowledge of a user.

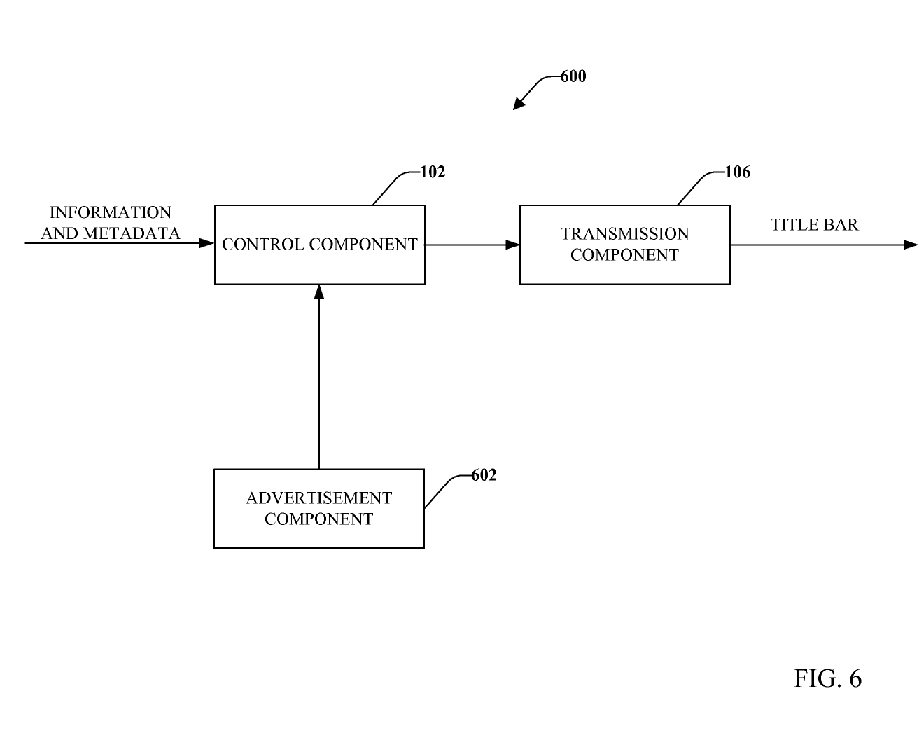

FIG. 6 discloses an example title bar display system 600 with an advertisement component 602. Information and metadata enter a control component 102. The control component 102 can transfer a non-default title bar to a transmission component 106 that can engage a display component for presentment of the non-default title bar. An advertisement component 602 can augment a title bar (including a non-default title bar) with announcement information. Announcement information can include commercial information (e.g., try this product) as well as non-commercial information (e.g., come to an outdoors club meeting.) According to one embodiment, a non-default title bar has a space reserved for an announcement

Announcements can be tailored specifically to pervious engagements of a user operating the device 600. For example, a user can receive a number of incoming messages relating to the sport of boxing. These can be incoming messages relating to boxing, telephone calls from boxing equipment supply companies, etc. The advertisement component 602 can augment a non-default title bar with a proclamation concerning an upcoming pay-per-view boxing bout.

Furthermore, the control component 102 can configure a priority scheme with announcement information. For example, to receive a device operating the system 600 at a discounted price, a non-default title bar that displays announcement information can be added to a priority scheme. The non-default title bar that displays announcement information can have a zero priority level and be presented after a set time (e.g., every thirty-six hours.)

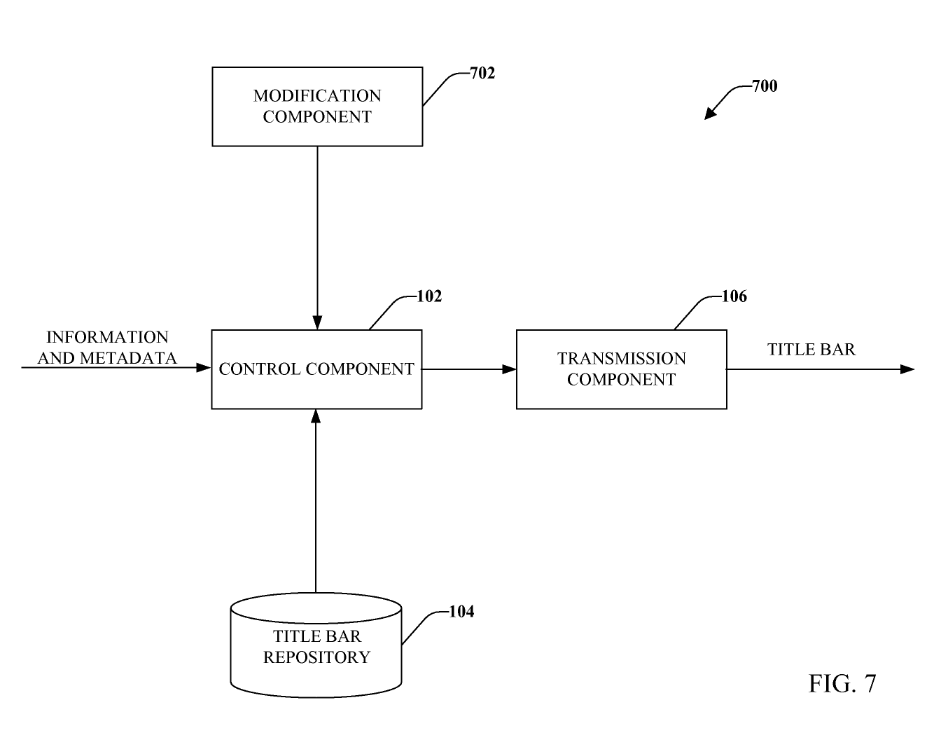

FIG. 7 discloses an example title bar display system 700 with a modification component 702. Information and metadata enter a control component 102. The control component 102 can transfer a non-default title bar extracted from a title bar repository 104 to a transmission component 106 that can engage a display component for presentment of the non-default title bar. A modification component 702 can be employed to allow a non-default title bar to be changed. A device operating the system 700 can have various non-default title bars pre-programmed. However, non-default title bars of the device are commonly designed with a goal of a general public and not tailored to needs of an individual user. Therefore, the modification component 702 allows a user to change a non-default title bar to individual specifications.

For example, a title bar providing information of an incoming call can display a phone number. However, a particular user can more readily identify individual names then telephone numbers. The user can engage the modification component 702 and change a text portion of a non-default title bar to include names of people associated with telephone numbers (e.g., through use of a ‘buddy list.’) The control component 102 can verify that a change is allowable through use of the check component 216 of FIG. 2. The control component 302 can send a modified non-default title bar to the title bar repository 104.

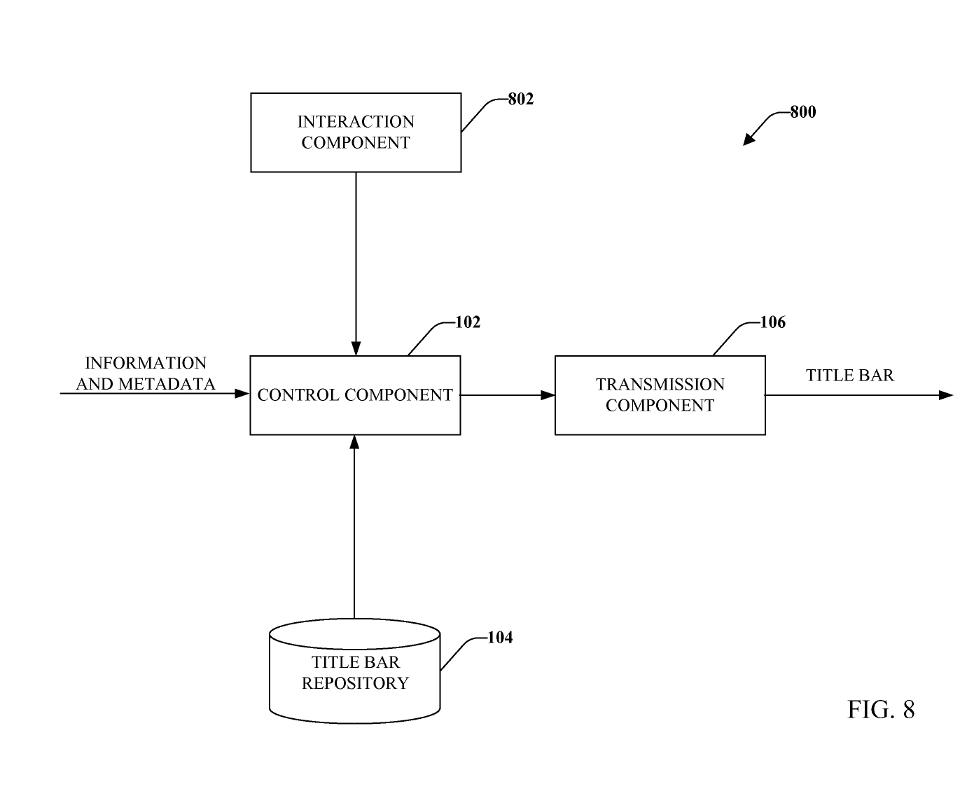

FIG. 8 discloses an example title bar display system 800 with an interaction component 802. Information and metadata enter a control component 102. The control component 102 can transfer a non-default title bar extracted from a title bar repository 104 to a transmission component 106 that can engage a display component for presentment of the non-default title bar. An interaction component 802 allows for augmentation of a non-default title bar with at least one engagement portion. Title bars can have at least one portion that facilitates user engagement. For example, a non-default title bar can include an icon that indicates when there is a received incoming message. A user can touch the icon with a stylus and the received incoming message displays in a non-title bar portion of a display. According to one embodiment, the interaction component 802 can keep a reminder that an icon can be engaged and receive a signal once there is engagement of the icon.

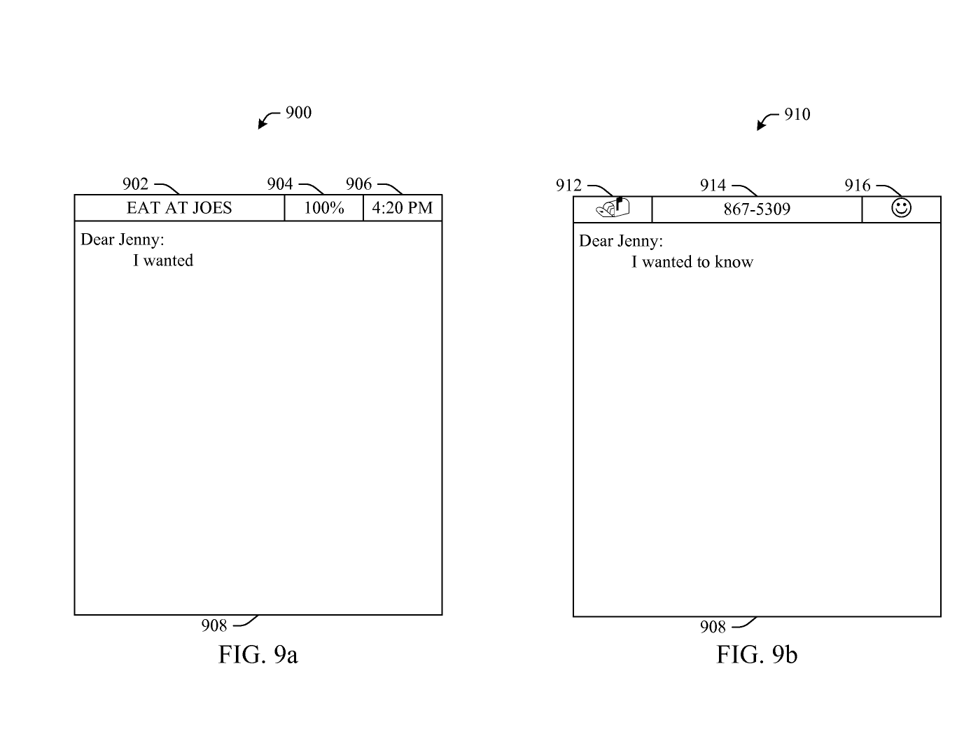

FIG. 9a discloses a display 900 with an example default title bar. A default title bar can contain general information concerning an electronic device. For example, a title bar shown as part of the display 900 includes an advertisement 902, battery life 904 and time 906. The display 900 can also run an application 908, such as a word processing application. A display portion running an application 908 can be considered the primary manipulation portion. A user is likely to use the portion in general interactions with the electronic device utilizing the display 900.

FIG. 9b discloses a display 910 with an example non-default title bar. A title bar can have specific portions that relates to information. For example, there can be a new voice message that is received by an electronic device with the display 910. An icon 912 can display that a new message has been received. The phone number 914 of a source of the new voice message can also be displayed. Furthermore, there can be an indicator 916 that discloses if a telephone number that send the message is on an approved list. The application 908 can be used while a non-default title bar is placed on top of a default title bar.

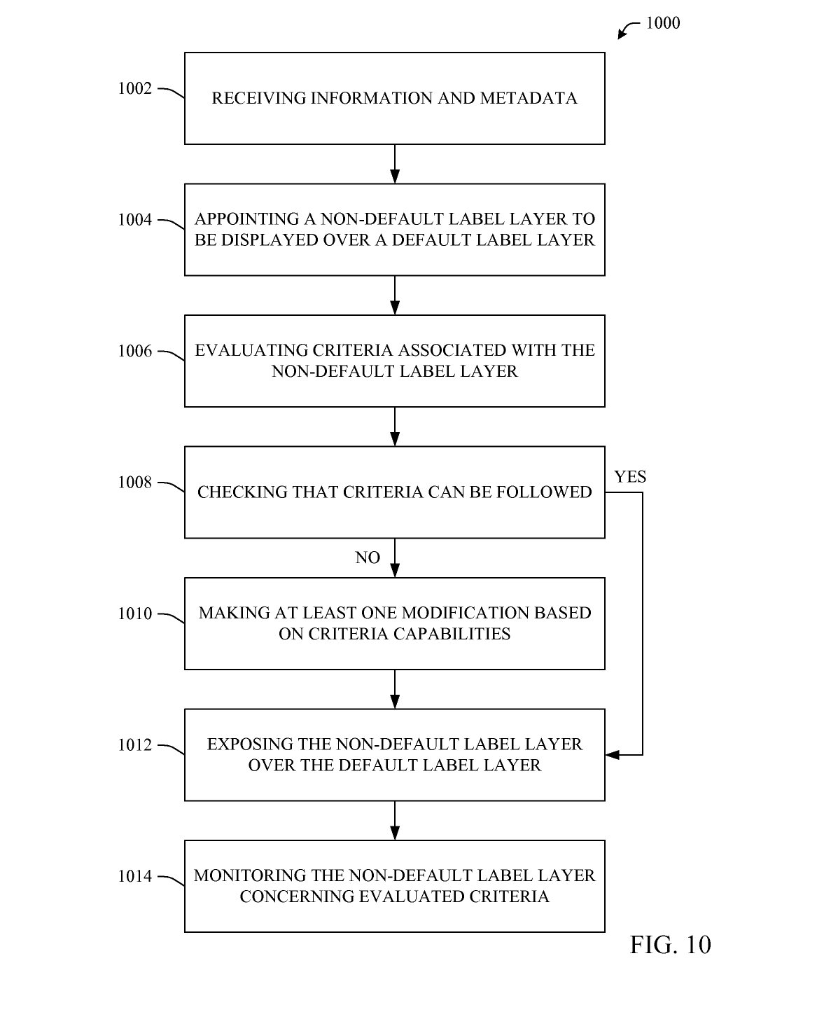

FIG. 10 discloses an example methodology 1000 for displaying a non-default label layer in accordance with related criteria. There can be receiving information and/or metadata 1002. Common received information and metadata can relate to an occurrence of an inbound service or metadata associated with the inbound service or execution of an internal application or a combination thereof.

Action 1004 can be appointing a non-default label layer to be displayed over a default label layer. Based on analysis of information and metadata, an appropriate non-default label layer is selected. This can be performed through a number of different embodiments. For example, a semi-random selection process can be used to make an appropriate appointment. Different non-default label layers can have equal priority (e.g., five incoming call non-default label layers with different advertisements.) A random draw is employed for appointment of the non-default label layer.

There can be evaluating criteria associated with the non-default label layer 1106. A non-default label layer can be associated with criteria. Criteria can include font size of text, pixel size, color depth, etc. Commonly, criteria are stored locally with the non-default label layer. In one embodiment, criteria enter the device with information and metadata (e.g., a message has metadata that a label layer should be green.)

Event 1008 can be checking that criteria can be followed. A device operating the methodology 1000 could be unable to run at least some criteria. For example, criteria can state an icon is to be displayed in color. However, a screen on the device can produce images in black and white, but not color. Therefore, a check takes place if a change should be made in presentment of a title bar. In another example, a limitation on following criteria can be voluntary. For example, a non-default label layer can be designed with an icon that flashes. However, to save power, a user can select that animations be disabled.

There can be making at least one modification based on criteria capabilities 1010. For example, there can be a label layer that is to be displayed in color. However, a display of a device using the methodology 1000 can present in black and white and action 1008 can identify a discrepancy (e.g., that color is to be displayed on black and white.) A modification can take place that presentment should be in black and white.

Exposing the non-default label layer over the default label layer 1012 can take place. Exposing the non-default label layer over the default label layer encompasses full exposing (e.g., the non-default label layer completely covers the default label layer) as well as partial exposing (e.g., at least a portion of the default label layer and at least a portion of the non-default label layer expose at one time, the default label layer can be partially seen through a partially transparent non-default label layer, etc.)

Act 1014 can be monitoring the non-default label layer concerning evaluated criteria. Some criteria can have requirements that benefit from monitoring. For example, one criterion can be a non-default label layer should display for about five seconds. There can be observation of when the non-default label layer engages to determine when the non-default label layer should disengage.

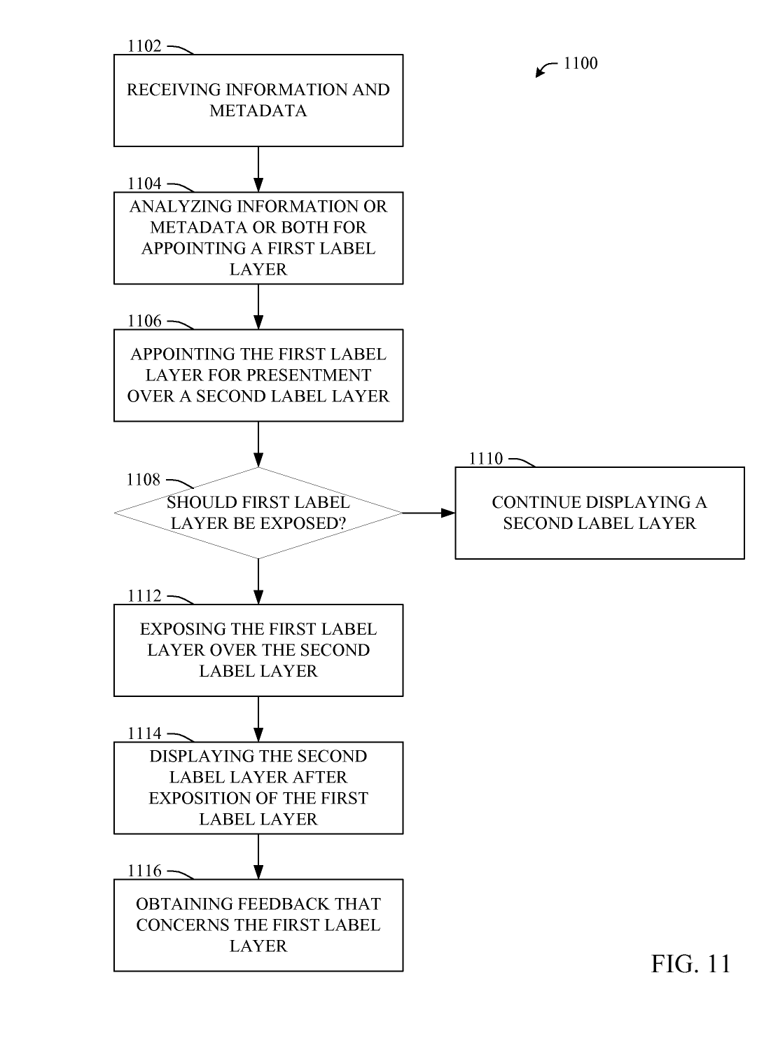

FIG. 11 discloses an example methodology 1100 for presentment of a non-default tile bar over a default label layer. For example, a first label layer can be a non-default label layer and a second label layer can be a default label layer. A device operating the methodology 1100 can partake in receiving information and metadata 1102. Examples of received information are a shipping invoice, an mp3 file, etc. Examples of metadata are a company that sent a shipping invoice, a song title of an mp3 file, etc.

There can be analyzing information or metadata or both for appointing a first label layer 1104. Analysis allows for various determinations that relate to a first label layer. For example, determining an information type can be important concerning what label layer will be displayed. Furthermore, different label layers can have different requirements. For example, a non-default label layer can have an area for text that relates to a sending source. Analysis of metadata can determine a source so it can be entered into the non-default label layer.

Action 1106 is appointing the first label layer for presentment over a second label layer. Based on analysis of information and metadata, an appropriate non-default label layer is selected. This can be accomplished through a number of different embodiments. For example, an algorithm can be used to make an appropriate appointment.

The methodology 1100 can ascertain if the first label layer should be exposed over a second label layer 1108. According to one embodiment, this can be a check to determine if there is an error in a non-default label layer. With one configuration, a determination is made if a non-default label layer is still applicable. For example, a spam message can be blocked and therefore there is no longer a need for display of a related non-default label layer. If the first label layer is not to be displayed, then the methodology continues to event 1110. There is continued display of the second label layer 1110 and thus continued display of the default label layer.

If the first label layer is to be displayed, then there is exposing the first label layer over the second label layer 1112. Commonly, exposing the first label layer over the second label layer 1112 is done for a temporary amount of time (e.g., an amount of time that allows a user to capture information relevant to the label layer.) Event 1114 is displaying the second label layer after exposition of the first label layer. The methodology 1100 can operate different label layers and thus a default layer can be lifted to the top once a non-default label layer is completed. However, this does not always take place. For example, a non-default label layer can relate to a power off operation of a device running the methodology 1100. Therefore, no label layer is displayed after a power off non-default label layer.

There can be obtaining feedback that concerns the first label layer 1116. Users can have different interactions that relate to non-default label layers. For example, a user can own a device that is very active and that receives a relatively large amount of communications. A large number of label layer changes can be distracting. The methodology 1100 can learn about distractions through action 1116 and make appropriate modifications to selection of label layers.

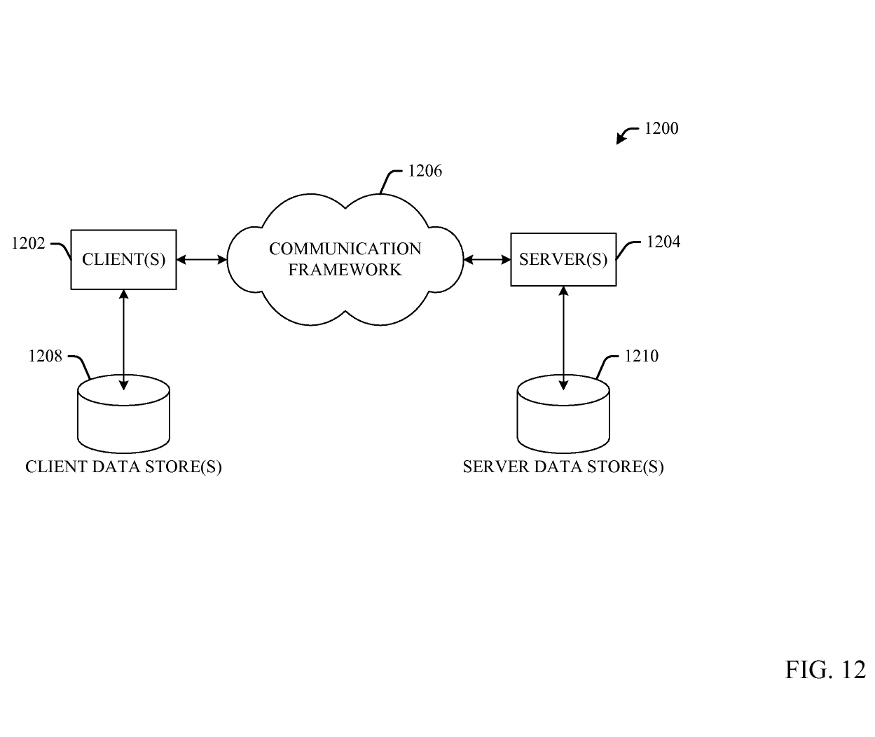

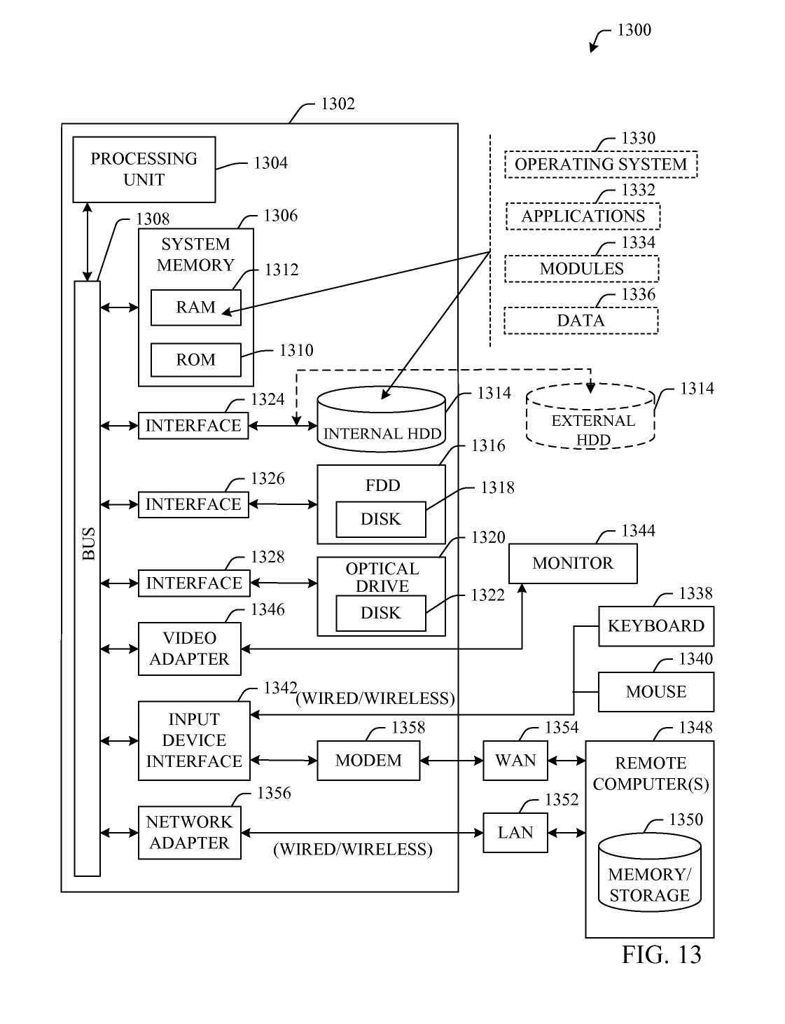

In order to provide a context for the various aspects of the disclosed subject matter, FIGS. 12 and 13 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject matter described herein also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

Referring now to FIG. 12, there is illustrated a schematic block diagram of a computing environment 1200 in accordance with the subject specification. The system 1200 includes one or more client(s) 1202. The client(s) 1202 can be hardware and/or software (e.g., threads, processes, computing devices). The client(s) 1202 can house cookie(s) and/or associated contextual information by employing the specification, for example.

The system 1200 also includes one or more server(s) 1204. The server(s) 1204 can also be hardware and/or software (e.g., threads, processes, computing devices). The servers 1204 can house threads to perform transformations by employing the specification, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

Referring now to FIG. 13, there is illustrated a block diagram of a computer operable to execute the disclosed architecture. In order to provide additional context for various aspects of the subject specification, FIG. 13 and the following discussion are intended to provide a brief, general description of a suitable computing environment 1300 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 13, the example environment 1300 for implementing various aspects of the specification includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures may also be employed as the processing unit 1304.

The system bus 1308 can be any of several types of bus structure that may further interconnect to a memory bus (with or without a memory controller), a peripheral bus, and a local bus using any of a variety of commercially available bus architectures. The system memory 1306 includes read-only memory (ROM) 1310 and random access memory (RAM) 1312. A basic input/output system (BIOS) is stored in a non-volatile memory 1310 such as ROM, EPROM, EEPROM, which BIOS contains the basic routines that help to transfer information between elements within the computer 1302, such as during start-up. The RAM 1312 can also include a high-speed RAM such as static RAM for caching data.

The computer 1302 further includes an internal hard disk drive (HDD) 1314 (e.g., EIDE, SATA), which internal hard disk drive 1314 may also be configured for external use in a suitable chassis (not shown), a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as the DVD). The hard disk drive 1314, magnetic disk drive 1316 and optical disk drive 1320 can be connected to the system bus 1308 by a hard disk drive interface 1324, a magnetic disk drive interface 1326 and an optical drive interface 1328, respectively. The interface 1324 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1302, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. It is appreciated that the specification can be implemented with various commercially available operating systems or combinations of operating systems.

A user can enter commands and information into the computer 1302 through one or more wired/wireless input devices, e.g., a keyboard 1338 and a pointing device, such as a mouse 1340. Other input devices (not shown) may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces, such as a parallel port, an IEEE 1394 serial port, a game port, a USB port, an IR interface, etc.

A monitor 1344 or other type of display device is also connected to the system bus 1308 via an interface, such as a video adapter 1346. In addition to the monitor 1344, a computer typically includes other peripheral output devices (not shown), such as speakers, printers, etc.

The computer 1302 may operate in a networked environment using logical connections via wired and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wired/wireless connectivity to a local area network (LAN) 1352 and/or larger networks, e.g., a wide area network (WAN) 1354. Such LAN and WAN networking environments are commonplace in offices and companies, and facilitate enterprise-wide computer networks, such as intranets, all of which may connect to a global communications network, e.g., the Internet.

When used in a LAN networking environment, the computer 1302 is connected to the local network 1352 through a wired and/or wireless communication network interface or adapter 1356. The adapter 1356 may facilitate wired or wireless communication to the LAN 1352, which may also include a wireless access point disposed thereon for communicating with the wireless adapter 1356.

When used in a WAN networking environment, the computer 1302 can include a modem 1358, or is connected to a communications server on the WAN 1354, or has other means for establishing communications over the WAN 1354, such as by way of the Internet. The modem 1358, which can be internal or external and a wired or wireless device, is connected to the system bus 1308 via the serial port interface 1342. In a networked environment, program modules depicted relative to the computer 1302, or portions thereof, can be stored in the remote memory/storage device 1350. It will be appreciated that the network connections shown are example and other means of establishing a communications link between the computers can be used.

The computer 1302 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a selection component that elects a non-default title bar for presentment over a default title bar of a device based on an occurrence of an inbound service or metadata associated with the inbound service or execution of an internal application or a combination thereof; and
a transfer component that conveys the non-default title bar to an auxiliary location.

2. The system of claim 1, further comprising a creation component that facilitates construction of a title bar that can be elected by the selection component.

3. The system of claim 1, further comprising an advertisement component that augments the non-default title bar with at least one announcement.

4. The system of claim 1, further comprising a modification component that facilitates alteration of a non-default title bar that can be elected by the selection component.

5. The system of claim 1, further comprising an interaction component that augments the non-default title bar with at least one engagement portion.

6. The system of claim 1, further comprising a check component that verifies applicability of the non-default title bar.

7. The system of claim 1, further comprising artificial intelligence that makes at least one inference or at least one determination or both that concerns election of the non-default title bar.

8. The system of claim 1, further comprising a statistical component gathers data that relates to the non-default title bar.

9. The system of claim 1, further comprising a collection component that obtains the non-default title bar elected by the selection component.

10. The system of claim 1, further comprising an augmentation component that integrates the elected non-default title bar with data that concerns occurrence of the inbound service or metadata associated with the inbound service or execution of the internal application or a combination thereof.

11. The system of claim 1, further comprising an analysis component that examines information or metadata or both that relates to occurrence of an inbound service or metadata associated with the inbound service or execution of an internal application or a combination thereof.

12. A method, comprising:
appointing a first label layer for presentment over a second label layer; and
exposing the first label layer over the second label layer.

13. The method of claim 12, further comprising analyzing information or metadata or both for appointing the first label layer.

14. The method of claim 13, further comprising receiving information or metadata or both.

15. The method of claim 12, further comprising displaying the second label layer after exposition of the first label layer.

16. The method of claim 12, further comprising ascertaining if the first label layer should be exposed over a second label layer.

17. The method of claim 12, further comprising obtaining feedback that concerns the first label layer.

18. A system, comprising:
means for overriding presentment of at least part of a standard banner panel; and
means for transferring a non-standard banner panel to a means for exhibiting the non-standard banner crosspiece panel.

19. The system of claim 18, further comprising means for regulating presentment of a non-standard banner panel in accordance with criteria of the non-standard banner panel.

20. The system of claim 18, further comprising means for exhibiting the non-standard banner panel.
